(19) United States
(12) Patent Application Publication
(10) Pub. No.: US 2006/0274041 A1
(43) Pub. Date: Dec. 7, 2006

(54) Mouse

(76) Inventor: Chang-Yong Han, Pohang-si (KR)

Correspondence Address: BLANK ROME LLP, 600 NEW HAMPSHIRE AVENUE, N.W., WASHINGTON, DC, 20037, US

(21) Appl. No.: 10/558,784

(22) PCT Filed: Dec. 17, 2004
(86) PCT No.: PCT/KR04/03349

§ 371 Date: Nov. 30, 2005

(30) Foreign Application Priority Data
Apr. 22, 2004 (KR) 10-2004-0027785

(51) Int. Cl. G09G 5/08

(52) U.S. Cl. 345/163

(57) ABSTRACT

A mouse according to the present invention, comprises: a casing; a button part disposed on the casing, for generating a click signal by being pressed; and a sensing part fixedly disposed on the casing in the vicinity of the button part in such a fashion as to be slantedly lower than the button part; an amplifying part built in the casing, for amplifying the clock signal generated from the sensing part, up to a predetermined level; a filtering part built in the casing, for regulating the signal amplified by the amplifying part, up to a predetermined level; and a switching part for outputting selectively and one from the signals applied thereto from the button part and the sensing part. Since the mouse operates in a touch-sensor fashion, clicking noise is avoided when in use.

### TECHNICAL FIELD

The present invention relates to a mouse, and more particularly to a computer mouse in which the button configuration is improved.

### BACKGROUND ART

A mouse is a kind of computer peripheral device, which is adapted to freely move a cursor by clicking its button. The mouse has plural buttons and a wheel selectively mountable therein, which are manipulated by fingers of a user.

In the conventional mouse, however, if a user uses fingers to click the buttons for a long time period, his or her bodily areas, especially fingers, wrists, arms, shoulders, etc. is fatigued by overstrain, and thus at an worse case may induce diseases.

As a countermeasure against the problem, Korean Patent Laid-Open Publication No. 2003-87688 discloses a contact clicking type mouse in which a click signal is generated when a user's finger is removed from a finger contact portion of the mouse.

This prior art is configured such that a mouse click signal is generated simply by detecting whether or not a user touches his or her finger on a finger contact surface or he or she removes the finger from the finger contact portion. Therefore, a user can advantageously operate the mouse without laboriously pressing the button.

However, since such a mouse requires a user to make reverse fingering that is contrary to a general user's accustomed behavior. That is, since a click signal is generated when a user detaches the finger from the mouse, it disadvantageously takes too long time for a user to adapt himself to manipulation of the mouse.

Moreover, since when in dragging operation a user should keep his finger in an untouched state from the finger contact portion, the finger gets overstrained and thus may induce diseases.

Further, in the case where a user moves a cursor by using the mouse, since the finger should be screening a sensor, there is a risk of malfunction all the time.

Another prior art, Korean Patent Laid-Open Publication No. 2000-35033 discloses a touch-type mouse in which a click signal is generated by finger touch. This has an advantage in that a user can easily adapt himself to manipulation of the mouse, because the mouse generates a click signal in the same way as the traditional mouse does.

However, since in this mouse a button is constructed only by a touch sensor, a user must concentrate his attention on his finger such that it does not unnecessarily touch the sensor, to prevent the malfunction during the mouse operation.

Moreover, in the case where the finger cannot directly touch the sensor, as in the case where a user's finger is covered with a kind of bandage to protect the scar on it, a mouse is cannot be operated by the finger.

### DISCLOSURE OF INVENTION

### Technical Problem

Therefore, the present invention has been made to solve the above-mentioned problems occurring in the conventional mouse, and it is an object of the present invention to provide a mouse of which the button mechanism is improved, in order to provide a user with convenience in use.

### Technical Solution

To achieve the above objects, according to the present invention, there is provided a mouse including: a button part for generating a signal by clicking a plurality of buttons; a sensing part fixedly disposed at a position of a casing where it can be manipulated by a user's finger, and adapted to generate a signal by bodily touching, so that a clicking operation identical to that of at least one button of the button part can be performed; an amplifying part for amplifying a clock signal generated by the sensing part, up to a predetermined level; a filtering part for regulating the signal amplified by the amplifying part, up to a predetermined level; a switching part for selectively outputting one from the signals applied thereto from the button part and the sensing part; and a signal processing part for processing the signal applied thereto from the switching part, and transmitting the processed signal to a computer.

In the above construction, the switching part is constructed, so that, if the sensing part and the button part generate signals simultaneously, it selects any one signal out of the signals from the sensing part and the button part; or so that, if a signal is inputted from either the button part or sensing part, it outputs the inputted signal as a click signal. In addition, the switching part may be constructed so that it does not respond to the signals simultaneously applied thereto from both the button part and the sensing part.

In addition, the sensing part is disposed at a front end of the button part along the longitudinal direction, or it is disposed beside the button part, in the traversing direction, at a lowered position.

Further, by employing a partitioning protrusion formed at the border between the sensing part and the button part, the unnecessary touching the sensing part when in use of a mouse can be avoided.

### Advantageous Effects

According to the present invention, a user can conveniently operate the mouse by using both a sensor and a button, both of which are disposed such that a user can operate them naturally. Therefore, the mouse of the present invention provides a user with an efficient operability without overstraining the user's body.

In addition, since a partitioning protrusion is formed between the sensor and the button so as to avoid the unexpected touching between a user's finger and the sensor, a user's unintended mouse clicking can be prevented, thereby giving the user the convenience in use. Additionally, a fact that the sensor is formed at the thumbing position gives the user the furthermore convenience in use.

Unlike the click-button type mouse, the touch-sensor type mouse according to the present invention does not make a clicking noise, and so it is useful to operate at night or at the place requiring a quiet and serene state.

### DESCRIPTION OF DRAWINGS

The above and other objects, features, and advantages of the present invention will become more apparent from the following description when taken in conjunction with the accompanying drawings, in which:

FIGS. 1 to 3 are perspective views showing a mouse according to an embodiment of the present invention;

FIG. 4 is a block diagram showing a functional construction of a mouse according to an embodiment of the present invention;

FIGS. 5 and 6 are circuit diagrams showing the inner construction of a mouse according to an embodiment of the present invention;

FIG. 7 shows a waveform of a signal generated from a sensing part; and

FIG. 8 shows a waveform of a signal outputted from a filtering part.

### BEST MODE FOR INVENTION

Hereinafter, preferred embodiments of the present invention will be described in detail with reference to the attached drawings.

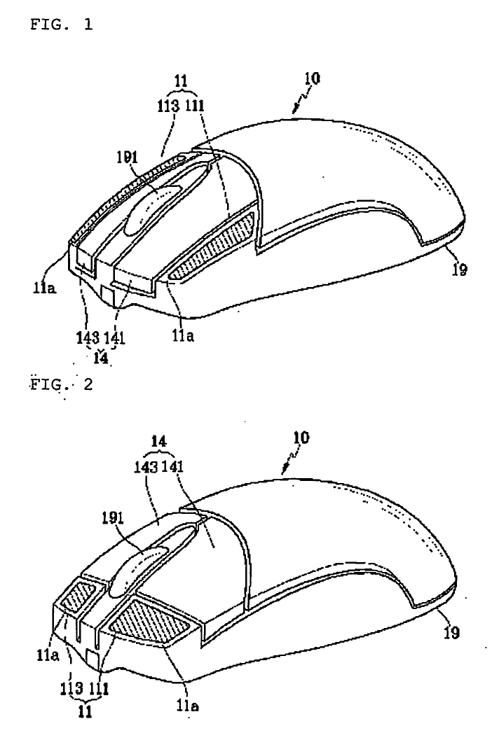

FIGS. 1 to 3 are perspective views showing a mouse according to an embodiment of the present invention. FIG. 1 shows that a sensing part is formed at the side of a button part. FIG. 2 shows that a sensing part is formed at the front of a button part. FIG. 3 shows that another sensing part is further formed at the thumb position.

A mouse 10 according to an embodiment of the present invention is composed of a casing 19 having a flat bottom surface and a round top surface such that a user can easily grasp the mouse; a button part 14 and a sensing part 11 for generating a click signal when a user manipulates them with him or her grasping the casing 19 with his or her hand; and an internal circuit part (not shown) for processing the signals from the button part 14 and the sensing part 11 and outputting the processed signal.

In the above construction, the button part 14 includes a left button 141 and a right button 143, which generate a click signal by being pressed with a finger of a user. Since such a construction of the button part 14 is already well known, the detailed description will be omitted here.

The sensing part 11 senses signal variations according to the bodily contact and generates a click signal identical to the signal generated by the neighboring button part 14. A sensor for sensing the signal variations in accordance with the bodily contact may include, for example, a proximate sensor, a resistive temperature sensor, a pressure sensor, a distance measuring sensor, an infrared sensor, a magnetic sensor, a touch sensor, etc. It can be understood that the sensors have been widely used for a touch pad of a notebook computer. The material of the contact surface of the sensing part 11 is preferably made of non-metallic materials, which give rise to good tactile sensation, such as a conductive rubber having resistance component, a conductive silicone, and the like. However, metallic materials may also be used for the present invention.

It is preferable that the sensing part 11 is positioned so as to provide a user with convenient usage. Therefore, the sensing part 11 should be disposed at the place where a user can directly touch it with minimized fingering motion when a user grips the mouse body.

Accordingly, the sensing part 11 is composed of a left and a right sensing part 111, 113 that are disposed on the casing 19 in such a fashion as to be supported by a support member 11a elongatedly formed in front of or beside the button part 14; and a lateral sensing part 115 disposed at the lateral side of the casing 190.

In the above construction, the left and right sensing parts 111, 113 are installed beside the left and right buttons 141, 143 as are shown in FIGS. 1 and 3, or in front of the left and right buttons 141, 143 as in FIG. 2. Further, in order to prevent a user's finger from unexpectedly touching the sensing part during operation and a mouse from malfunctioning, the sensing surface of the sensing part 11 is preferably formed to be lower than the button part 14, by curving the relevant portions along the rounded body. Or, a partitioning protrusion 16 may be formed at the border between the sensing surface of the sensing part 11 and the button part 14.

As is shown in FIG. 3, the lateral sensing part 115, which generates the signal identical to the left button part 141, is formed at the lateral side of the casing 19 being thumbed when a user grasps the mouse body. In order to prevent the thumb from unnecessarily touching the lateral sensing part 114 during operation, it is formed in a somewhat higher position than the typical thumbing position when a user grips the mouse body.

Meanwhile, between the left and right buttons 141, 143 may be provided a wheel 191.

Like the above, since the sensing part 11 is disposed so as to adjoin the button part 14, a user can operate the mouse just by either pressing the button part 14 or touching the sensing part 11 where there is his finger naturally. In addition, since either the partitioning protrusion 16 is formed between the sensing part 11 and the button part 14 or the sensing part 11 is formed to be lower than the button part 14, the unnecessary or unintended touching of the sensing part 11 can be avoided.

Now, the operation of the mouse such constructed as above will be described more in detail, with reference to a construction of a circuit part.

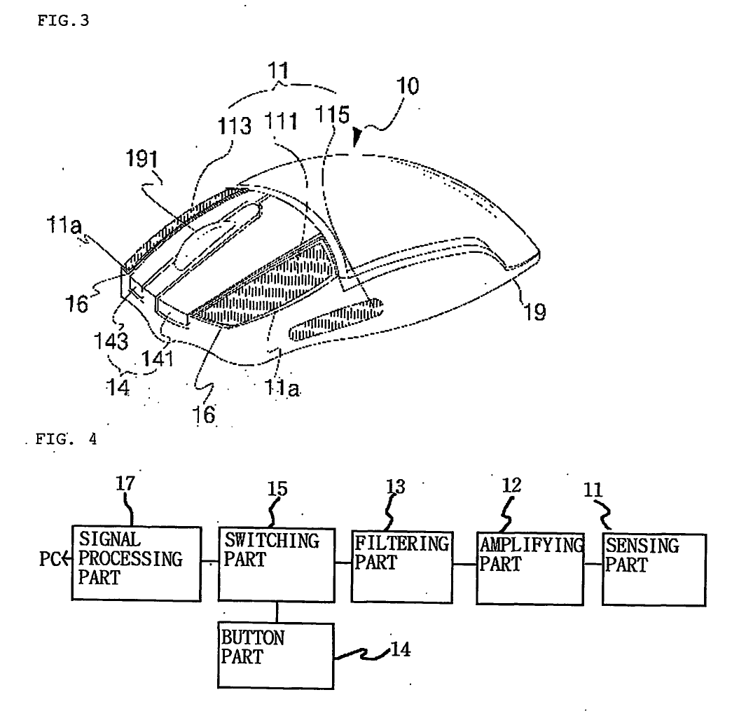

FIG. 4 is a block diagram showing a construction of a circuit part of the mouse according to the present invention. The circuit part includes the sensing part 11, an amplifying part 12, a filtering part 13, the button part 14, a switching part 15, and a signal processing part 17.

In the circuit part, the respective click signals generated from the sensing part 11 or the button part 14 is selectively delivered to a computer by the operation of the switching part 15 and the signal processing part 17.

The amplifying part 12 amplifies the signal, which is generated from the sensing part 11 by fingering, up to a regular level. An OP-amp may be preferably used for the amplifying part 12.

The filtering part 13 regulates the signal amplified by the amplifying part 12 up to a given level. For example, it may output a signal as high state of 5 volts in response to the input signal. A transistor, a diode, or thee like may be preferably used for the filtering part 13.

The switching part 15 selects one signal out of the signals from the button part 14 and the sensing part 11 so as to provide the selected signal to the signal processing part 17. Preferably, a flip-flop logic circuit is used for, but not limited to, the switching part 15.

The signal processing part 17 processes the click signal applied thereto from the switching part 15, and transmits the processed signal to a computer. Since the construction of the signal processing part 17 is well known, the detailed description thereof will be omitted.

The operation of the circuit part constructed as above will be discussed with regard to the circuit diagrams.

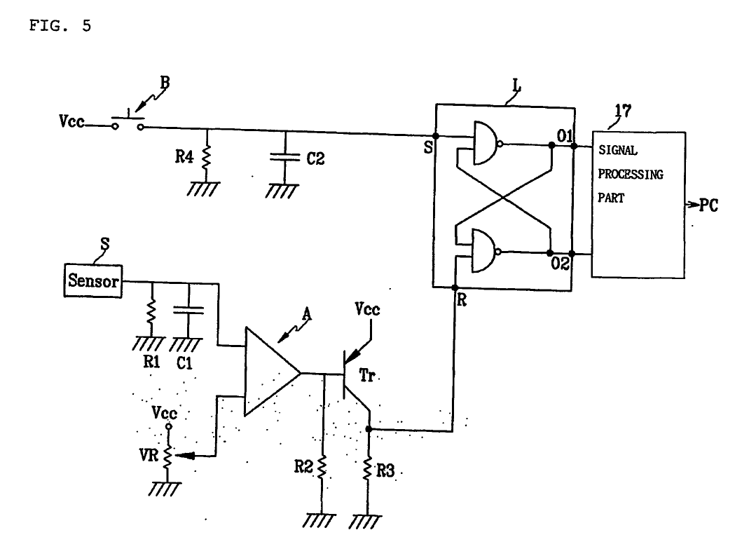

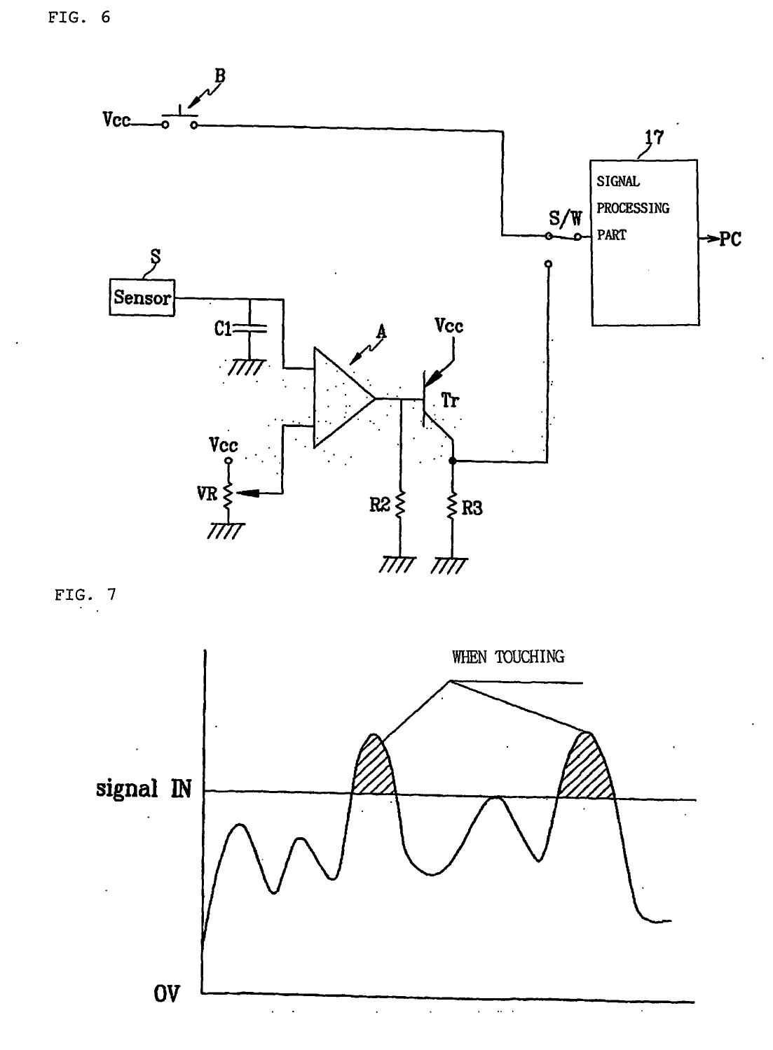

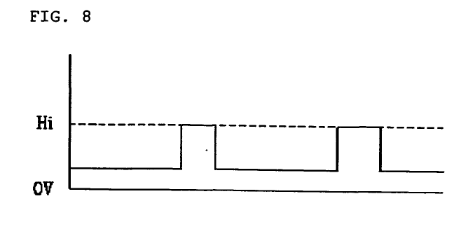

FIGS. 5 and 6 are circuit diagrams showing the circuit diagrams of the mouse according to an embodiment of the present invention; FIG. 7 exemplary shows a waveform of a signal generated from the sensing part; and FIG. 8 exemplary shows a waveform of a signal outputted from the filtering part.

With reference to the drawings, a sensor S is connected to one input port of an OP-amp A, and a capacitor C1 is connected therebetween in parallel. The other input port of the OP-amp A is biased by a reference voltage Vcc. Therefore, if the capacitance of the capacitor C1, and therefore the voltage across it, is varied according to a finger touch, the voltage variation is compared to the reference voltage, and accordingly the signal higher than the reference voltage appears at the output port of the OP-amp A (See FIG. 7). In FIG. 7, the hashed portions refer to the signal components sensed by the OP-amp A.

Also, the output port of the OP-amp A is connected to the base of a transistor Tr. The emitter of the transistor Tr is biased by the reference voltage Vcc, and a load resistor R3 is connected to an output port of the collector of the transistor, thereby determining the signal level outputted from the transistor Tr. FIG. 8 shows the waveform of the output signal through the transistor Tr from the signal detected at the OP-amp A. That is, the signal inputted from the sensor S passes through the transistor Tr, and is outputted as a regular leveled signal, for example a high state of +5 volts.

The collector of the transistor Tr is connected to one input port of a flip-flop logic operator L, such as an RS-FFIG.

In the mean time, to the other input port of the logic operator L is connected a push button B, and a capacitor C2 is connected therebetween in parallel. According to the variance in the capacitance of the capacitor C3, a click signal is generated and provided to the logic operator L.

Accordingly, the logic operator L processes the input signal as shown in Table 1 below, and provides the processed signal to the signal processing part 17.

TABLE 1

| | |
|---|---|
| Input | Output |

| R | S | O1 | O2 |
|---|---|---|---|
| 0 | 0 | Remains the | Remains the |
| | | previous value | previous value |
| 0 | 1 | 0 | 1 |
| 1 | 0 | 1 | 0 |
| 1 | 1 | — | — |

The logic operator L operates the signal applied thereto from either the sensor S or the push button B, and outputs the resulting value as either ‘1’ or ‘0’ to the signal processing part 17 through its output terminals O1, O2. On the other hand, the logic operator L does not respond to the click signals simultaneously applied thereto from both the sensor S and the push button B.

Meanwhile, the signal processing part 17 adds the aforementioned ‘1’ and ‘0’ signals applied thereto from the logic operator L, and then delivers the added click signal to a computer.

Therefore, since the mouse of this embodiment operates selectively with regard to the input signals from the sensor S and the button B, the stable signal processing becomes possible without any malfunction.

Further, since a user can operate the mouse with either the button or the sensor free of concerning about the malfunctioning, the usability and the work efficiency can be increased.

In the mean time, the construction of FIG. 6 is generally identical to that of FIG. 5, but the circuit of FIG. 6 uses, instead of the logic operator L, a switch S/W for selecting one click signal out of the signals from the push button B and the sensor S. Therefore, the mouse of this embodiment is constructed such that either the button or the sensor operates only.

Although the above embodiment shows that the sensing part is disposed both in the vicinity of the left and right buttons and at the place where the thumb is situated, it may be selectively disposed either in the vicinity of the left button or where the thumb is situated, or at any place in the vicinity of the left and right buttons or where the thumb is situated.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A mouse comprising:
a button part for generating a signal by clicking a plurality of buttons;
a sensing part fixedly disposed at a position of a casing where it can be manipulated by a user's finger, and adapted to generate a signal by bodily touching, so that a clicking operation identical to that of at least one button of the button part can be performed;
an amplifying part for amplifying a clock signal generated by the sensing part, up to a predetermined level;
a filtering part for regulating the signal amplified by the amplifying part, up to a predetermined level;
a switching part for selectively outputting one from the signals applied thereto from the button part and the sensing part; and
a signal processing part for processing the signal applied thereto from the switching part, and transmitting the processed signal to a computer.

2. The mouse according to claim 1, wherein the switching part does not respond to the signals simultaneously applied thereto from both the button part and the sensing part.

3. The mouse according to claim 1, wherein the sensing part is disposed at a front end of the button part along the longitudinal direction.

4. The mouse according to claim 1, wherein the sensing part is disposed beside the button part in the traversing direction.

5. The mouse according to claim 1, wherein a sensing part corresponding to a left button of a mouse, is disposed either in the vicinity of the left button of the mouse or at the place where a thumb is situated, or both.

6. The mouse according to claim 5, wherein a sensing part manipulated by a thumb is formed in a higher position than a typical thumbing position.

7. The mouse according to claim 1, wherein a longitudinal partitioning protrusion is further formed at the border between the sensing part and the button part.

8. The mouse according to claim 1, wherein the sensing part includes any one selected from the group consisting of a proximate sensor, a resistive temperature sensor, a pressure sensor, a distance measuring sensor, an infrared sensor, a magnetic sensor, and a touch sensor, for sensing the bodily touching.

9. A mouse comprising:
a casing having a drive circuit built therein;
a button disposed on the casing, for generating a click signal by being pressed; and
a support member elongatedly formed on the casing along the button part, for parallelly supporting the sensing part with regard to the button part,
wherein the drive circuit comprises:
a sensor for sensing a click signal according to a variation in capacitance of a first capacitor connected thereto in parallel;
an OP-amp connected to the sensor, for amplifying the click signal applied thereto from the sensor up to a predetermined level, according to a magnitude of a variable resistor connected to the other input port of the OP-amp;
a transistor connected to an output port of the OP-amp, for regulating the click signal applied thereto from the OP-amp up to a predetermined level;
a button for generating a click signal by varying capacitance of a second capacitor connected therewith in parallel; and
a logic operator connected to the transistor and the button, for processing in an RS flip-flop scheme the click signal applied thereto from the transistor and the button.

10. The mouse according to claim 3, wherein a longitudinal partitioning protrusion is further formed at the border between the sensing part and the button part.

11. The mouse according to claim 4, wherein a longitudinal partitioning protrusion is further formed at the border between the sensing part and the button part.

12. The mouse according to claim 5, wherein a longitudinal partitioning protrusion is further formed at the border between the sensing part and the button part.
